(19) United States
(12) Patent Application Publication
(10) Pub. No.: US 2024/0372177 A1
(43) Pub. Date: Nov. 7, 2024

(54) BUTTON-TYPE SECONDARY BATTERY

(71) Applicant: LG ENERGY SOLUTION, LTD., Seoul (KR)

(72) Inventors: Yeong Hun JUNG, Daejeon (KR); Young Ji TAE, Daejeon (KR); Joo Hwan SUNG, Daejeon (KR); Min Su CHO, Daejeon (KR); Geun Young PARK, Daejeon (KR); Min Gyu KIM, Daejeon (KR); Min Seon KIM, Daejeon (KR); Sang Hak CHAE, Daejeon (KR); Min Young JU, Daejeon (KR)

(73) Assignee: LG ENERGY SOLUTION, LTD., Seoul (KR)

(21) Appl. No.: 18/688,634

(22) PCT Filed: Oct. 6, 2022
(86) PCT No.: PCT/KR2022/015058

§ 371 Date: Mar. 1, 2024

(30) Foreign Application Priority Data
Oct. 7, 2021 (KR) 10-2021-0133529

(51) Int. Cl. H01M 50/109; H01M 10/04; H01M 50/153; H01M 50/169; H01M 50/567; H01M 50/586; H01M 50/588

(52) U.S. Cl. CPC H01M 50/109; H01M 10/0431; H01M 50/153; H01M 50/169; H01M 50/567; H01M 50/586; H01M 50/588

(57) ABSTRACT

A button-type secondary battery includes: an electrode assembly in which a positive electrode, a separator, and a negative electrode are alternately disposed; a can housing including a bottom part and a sidewall extending upward from a circumference of the bottom part to form an internal space, the electrode assembly being disposed in the internal space; a base plate configured to cover an upper opening of the sidewall and coupled to the can housing; a positive electrode terminal having a rivet shape coupled to a through-hole formed in the sidewall; an insulating gasket configured to insulate the positive electrode terminal and the can housing from each other; a positive electrode tab having one side connected to the positive electrode and the other side connected to the positive electrode terminal; and a negative electrode tab having one side connected to the negative electrode and the other side connected to the sidewall.

### CROSS-REFERENCE TO RELATED APPLICATION

The present application claims the benefit of the priority of Korean Patent Application No. 10-2021-0133529, filed on Oct. 7, 2021, which is hereby incorporated by reference in its entirety.

### TECHNICAL FIELD

### Technical Field

The present invention relates to a button-type secondary battery, in which a height of an electrode assembly inside a button cell increases, and thus, battery capacity increases, and when an upper portion of a cell is pressed by an impact bar during an impact test that is one of button cell certification tests, a pressure of the electrode assembly is distributed throughout the electrode assembly to prevent positive/negative electrode short-circuits due to damage of a specific area and prevent resulting explosion from occurring.

### Background Art

In recent years, the price of energy sources increases due to the depletion of fossil fuels, the interest in environmental pollution is amplified, and the demand for eco-friendly alternative energy sources is becoming an indispensable factor for future life. Accordingly, studies on various power generation technologies, such as solar power, wind power, and tidal power, are continuing, and power storage devices, such as batteries, for more efficiently using the generated electrical energy are also of great interest.

Furthermore, as technology development and demand for electronic mobile devices and electric vehicles using batteries increase, the demands for batteries as energy sources are rapidly increasing. Thus, many studies on batteries which are capable of meeting various demands have been conducted.

In particular, in terms of materials, there is a high demand for lithium secondary batteries, such as lithium ion batteries and lithium ion polymer batteries, having such advantages as high energy density, discharge voltage, and output stability.

The secondary batteries may be classified into, among others, cylindrical batteries and prismatic batteries, in which an electrode assembly is embedded in a cylindrical or prismatic metal can, and pouch-type batteries, in which an electrode assembly is embedded in a pouch-type case made of an aluminum laminate sheet, according to shapes of battery cases. In addition, recently, due to the trend of smaller wearable devices, the importance of developing small batteries, such as button-type secondary batteries, has been highlighted.

FIG. 1 is a cross-sectional view of a button-type secondary battery according to a related art.

With reference to FIG. 1, a conventional button-type secondary battery 1 has a shape in which an electrode assembly 10 is inserted into a container-shaped can housing 20 having an opening at an upper portion thereof. An upper opening of the can housing 20 may be covered by a base plate 30, and thus, the battery may be sealed. The can housing 20 includes a bottom part 21 and a sidewall 22 extending upward from a circumference of the bottom part 21, and the base plate 30 is coupled to the upper opening of the sidewall 22. A through-hole 31 is formed in the upper base plate 30, and a rivet-shaped positive electrode terminal 40 is coupled to the through-hole 31.

The positive electrode terminal 40 has a capital letter I shape and is coupled to the through-hole 31 of the base plate 30. In addition, a positive electrode tab 70 having one side connected to a positive electrode 11 of the electrode assembly 10 has the other side connected to a positive electrode terminal 40, and a negative electrode tab 80 having one side connected to a negative electrode 12 of the electrode assembly 10 has the other side connected to a bottom part 21 of a can housing 20. When connected in this manner, each of the can housing 20 and the base plate 30 have negative polarity, and the positive electrode terminal 40 has positive polarity. Therefore, insulation is required between the positive electrode terminal 40 and the base plate 30, and for this purpose, an insulating gasket 50 may be provided between the positive electrode terminal 40 and the base plate 30.

In the related art, a button-type secondary battery may be formed in this manner, but in this case, there is a problem in that capacity of the electrode assembly 10 is limited. That is, since the rivet-type positive electrode terminal 40 has the I-shape for coupling, the positive electrode terminal 40 includes a portion protruding downward from a bottom surface of the base plate 30 (inside the battery). Thus, a height of the electrode assembly 10 is not sufficiently high. In the electrode assembly in the battery, a height between the bottom part 21 of the can housing 20 and the lowermost surface of the positive electrode terminal 40 has to be the maximum and usually has to have a height less than a general height. Thus, it is necessary that the battery capacity is limited.

FIG. 2 is a cross-sectional view illustrating a case in which an impact test, which is one of button cell authentication tests, is performed on a button-type secondary battery according to the related art. FIG. 2 illustrates a state in which an impact bar B applies an impact to the button-type secondary battery according to the related art during the impact test.

With reference to FIG. 2, in the related art, during the impact test, there is a problem in that damage of a jelly roll-type electrode assembly 10 is intensified due to the upper rivet-shaped positive electrode terminal 40. The impact bar B may apply an impact from an upper portion to a lower portion of the button-type secondary battery to strike the button-type secondary battery, and thus, the rivet-type positive terminal 40 disposed at the upper portion may be hit by the impact bar and thus be strongly struck downward toward the electrode assembly 10. In this case, as illustrated in FIG. 2, both lower ends of the positive electrode terminal 40 made of a metal are inserted while locally destroying the electrode assembly 10. As described above, when the electrode assembly 10 is locally impacted, a degree of damage becomes severe, probability of an occurrence of positive/negative electrode short-circuits due to damage of a specific area is high, and thus, probability of an explosion also increases.

### DISCLOSURE OF THE INVENTION

### Technical Objective

The present invention has been made to solve the above problems and is to provide a button-type secondary battery, in which a height of an electrode assembly inside a button cell increases, and thus, battery capacity increases, and when an upper portion of a cell is pressed by an impact bar during an impact test that is one of button cell certification tests, a pressure of the electrode assembly is distributed throughout the electrode assembly to prevent positive/negative electrode short-circuits due to damage of a specific area and prevent resulting explosion from occurring.

### Technical Solution

A button-type secondary battery according to the present invention relates to a button-type secondary battery having a shape of which a diameter is greater than a height, the button-type secondary battery including: an electrode assembly in which electrodes and a separator are alternately disposed; a can housing including a bottom part and a sidewall extending upward from a circumference of the bottom part and provided so that the electrode assembly is inserted into an internal space formed by the bottom part and the sidewall; a base plate configured to cover the upper opening of the sidewall and coupled to the can housing; a positive electrode terminal having a rivet shape coupled to a through-hole formed in the sidewall; an insulating gasket configured to insulate the positive electrode terminal and the can housing from each other; a positive electrode tab having one side connected to a positive electrode of the electrode assembly and the other side connected to the positive electrode terminal; and a negative electrode tab having one side connected to a negative electrode of the electrode assembly and the other side connected to the sidewall.

An edge of the base plate and the upper opening of the sidewall may be coupled to each other by laser welding.

The electrode assembly may have a height corresponding to a height of the sidewall.

The button-type secondary battery may further include an insulating sheet configured to surround a circumference of the positive electrode tab.

The through-hole may be formed biased upward from a middle height of the sidewall, and the negative electrode tab may be connected to a height biased downward from the middle height of the sidewall.

The positive electrode terminal may include: an external terminal part disposed outside the can housing; an internal terminal part disposed inside the can housing; and a connection terminal part configured to connect the external terminal part to the internal terminal part.

The electrode assembly may include a jelly-roll type electrode assembly in which the electrodes and the separator are alternately disposed to be wound, and the positive electrode tab may have one side connected to the outermost positive electrode of the electrode assembly and the other side connected to an inner surface of the positive electrode terminal.

The electrode assembly may include a jelly-roll type electrode assembly in which the electrodes and the separator are alternately disposed to be wound, and the negative electrode tab may have one side connected to the outermost negative electrode of the electrode assembly and the other side connected to an inner surface of the sidewall.

The external terminal part may include: a first surface facing the outside; and a second surface that is a surface facing the insulating gasket as a surface opposite to the first surface, wherein the first surface may be formed as a flat surface, and the second surface is formed as a curved surface.

The internal terminal part may include: a third surface facing the insulating gasket; and a fourth surface that is a surface facing the electrode assembly as a surface opposite to the third surface, wherein each of the third surface and the fourth surface may be formed as a curved surface.

### Advantageous Effects

In the button-type secondary battery according to the present invention, the height of the electrode assembly inside the button cell may increase, and thus, the battery capacity may increase, and when the upper portion of the cell is pressed by the impact bar during the impact test that is one of the button cell certification tests, the pressure of the electrode assembly may be distributed throughout the electrode assembly to prevent the positive/negative electrode short-circuits due to the damage of the specific area and prevent the resulting explosion from occurring.

### BRIEF DESCRIPTION OF THE DRAWINGS

FIG. 1 is a cross-sectional view of a button-type secondary battery according to a related art.

FIG. 2 is a cross-sectional view illustrating a case in which an impact test, which is one of button cell authentication tests, is performed on the button-type secondary battery according to the related art.

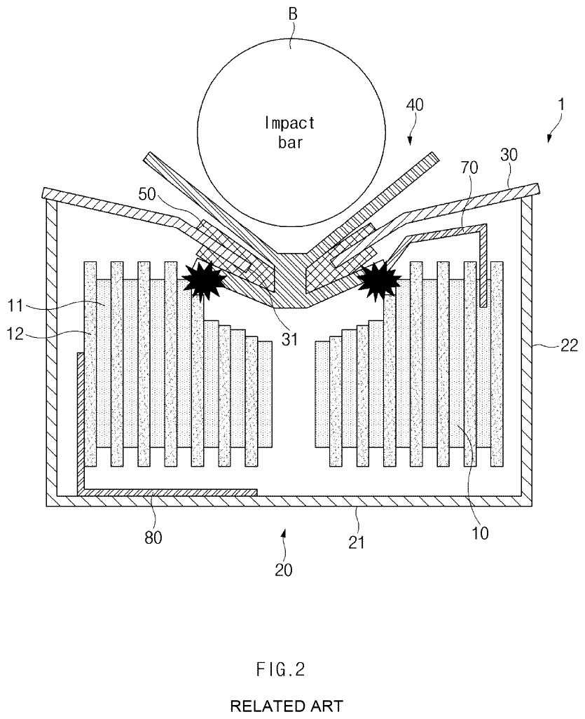

FIG. 3 is a cross-sectional view of a button-type secondary battery according to Embodiment 1 of the present invention.

FIG. 4 is a cross-sectional view illustrating a case in which an impact test, which is one of button cell authentication tests, is performed on the button-type secondary battery according to Embodiment 1 of the present invention.

FIG. 5 is a plan view of a button-type secondary battery according to Embodiment 2 of the present invention.

### MODES FOR CARRYING OUT THE INVENTION

Hereinafter, preferred example embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Embodiment 1

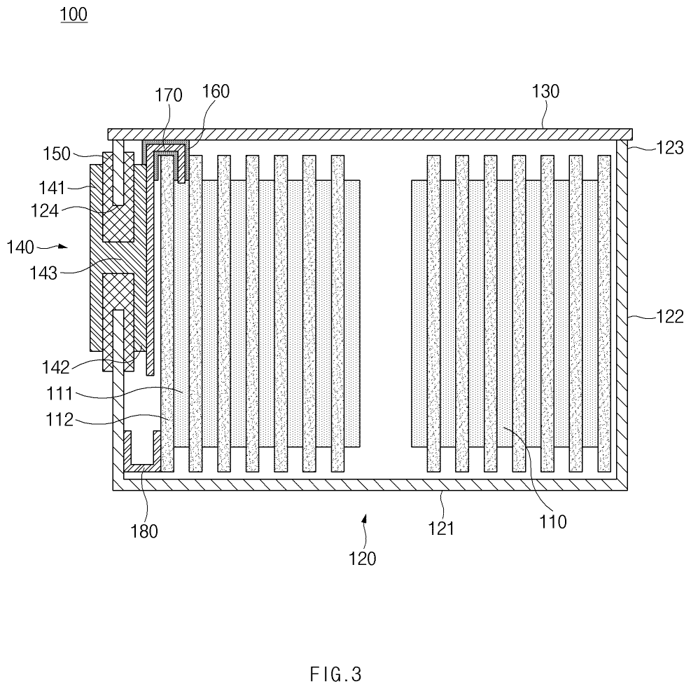

FIG. 3 is a cross-sectional view of a button-type secondary battery according to Embodiment 1 of the present invention.

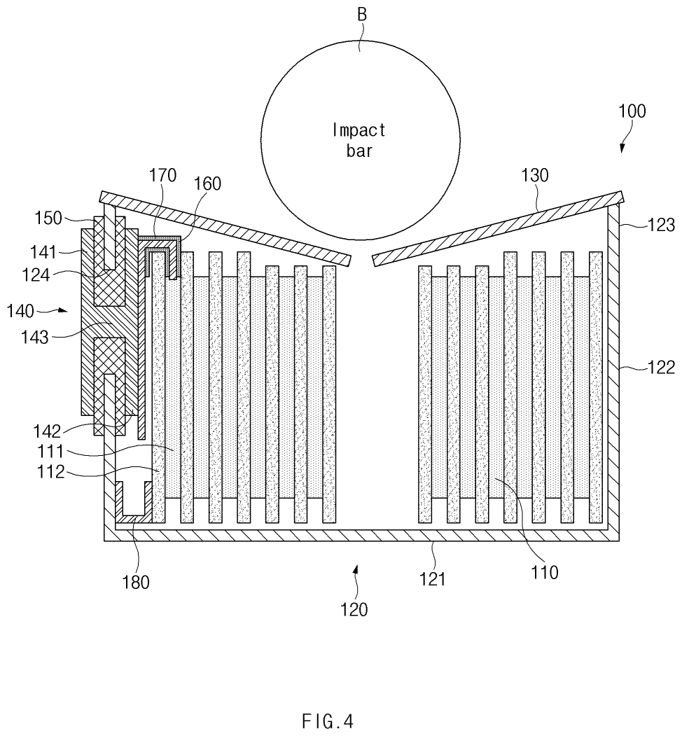

FIG. 4 is a cross-sectional view illustrating a case in which an impact test, which is one of button cell authentication tests, is performed on the button-type secondary battery according to Embodiment 1 of the present invention.

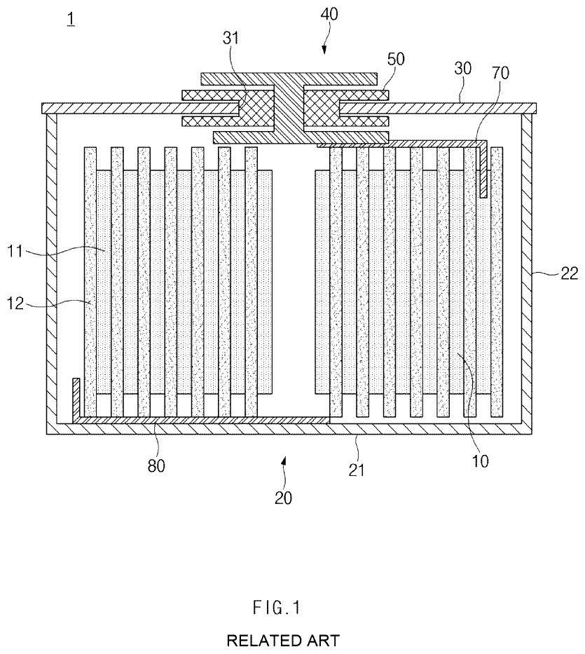

With reference to FIG. 1, a button-type secondary battery 100 according to Embodiment 1 of the present invention may be a button-type secondary battery 100 of which a diameter is greater than a height. Also, the button-type secondary battery 100 according to Embodiment 1 of the present invention may include an electrode assembly 110, a can housing 120, a base plate 130, an electrode terminal 140, an insulating gasket 150, a positive electrode tab 170, and a negative electrode tab 180.

The electrode assembly 110 may be formed by alternately disposing a positive electrode, a separator, and a negative electrode. The electrode assembly 110 may be a jelly roll-type electrode assembly 110 in which the electrodes and the separator are alternately disposed and wound. The electrode assembly 110 may be an electrode wound body in which one or more positive electrodes, one or more negative electrodes, and one or more separators are wound on each other.

The can housing 120 may have a configuration in which the electrode assembly 110 is inserted. The can housing 120 may have an internal space, and the electrode assembly 110 may be vertically inserted into the internal space. The vertical insertion may mean that the electrode assembly 110 is inserted so that a winding axis of the electrode assembly is perpendicular to a bottom part of the can housing 120. The can housing 120 may have an opening at an upper side thereof. That is, the can housing 120 may have the opened upper side and include a bottom part 121 and a sidewall 122. Particularly, the can housing 120 may include the bottom part 121 and the sidewall 122 extending upward from a circumference of the bottom part 121 and may be configured so that the electrode assembly 110 is inserted into the internal space in which the bottom part 121 and the sidewall 122 are formed. Here, a through-hole 124 to which a positive electrode terminal 140 is coupled may be formed in the sidewall 122.

The base plate 130 may cover an upper opening 123 of the can housing 120 and be coupled to the can housing 120. This bonding may be bonding using welding. Particularly, an edge 132 of the base plate and the upper opening 123 of the sidewall may be coupled to each other by laser welding. A portion at which the edge 132 of the base plate and the opening 123 of the can housing are welded by welding may be a welding part 170.

Also, this type of laser welding may be seam welding that is advantageous for preventing a welding pin hole. Here, the base plate may be made of a metal material, and the metal material may be at least one or more selected from SUS, nickel-plated carbon steel, and Al.

The positive electrode terminal 140 may be a terminal coupled to the through-hole 124 formed inside the sidewall 122. The positive electrode terminal 140 may have a rivet shape. That is, the positive electrode terminal 140 may have an I-shape and be riveted to the sidewall 122. The positive electrode terminal 140 may be a positive electrode terminal having positive polarity. This may be a result of the positive electrode of the electrode assembly 110 being connected to the positive electrode terminal 140.

FIG. 3 illustrates a state in which a positive electrode tab 170 extending from the positive electrode of the electrode assembly 110 is connected to the positive electrode terminal 140. Particularly, the positive electrode tab 170 may have one side connected to the positive electrode of the electrode assembly 110 and the other side connected to the positive electrode terminal 140. Particularly, the positive electrode tab may have one side connected to the outermost positive electrode 111 of the electrode assembly 110.

When the positive electrode terminal 140 forms the positive polarity, the can housing 120 and the base plate 130 may form the negative polarity. The negative electrode of the electrode assembly 110 may be connected to the can housing 120 so that the can housing 120 has the negative polarity. As the base plate 130 is welded to the can housing 120, the same negative polarity as the can housing 120 may be formed. The negative electrode tab 180 may be connected to the sidewall 122 of the can housing 120. In the button-type secondary battery according to Embodiment 1 of the present invention, the negative electrode tab 180 may have one side connected to the outermost negative electrode 112 of the electrode assembly 110 and the other side connected to the sidewall 122. As a result, each of the sidewall 122 and the bottom part 121 connected to the sidewall have the negative polarity.

The positive electrode terminal 140 may be inserted into the through-hole 124 formed in the sidewall and cover the through-hole 124. The positive electrode terminal 140 may be made of a metal material, and the metal material may be any one or more selected from SUS, nickel-plated carbon steel, and Al. The positive electrode terminal 140 may be configured to be connected to an electrode (positive electrode) of the electrode assembly through the electrode tab and may be a portion forming a terminal through which the battery is connected to an external device.

The insulating gasket 150 may be configured to insulate the positive electrode terminal 140 from the can housing 120. That is, the insulating gasket 140 may be configured to prevent the short circuit from occurring between the positive electrode terminal 140 and the can housing 120. When the positive electrode terminal 140 forms the positive polarity, the can housing 120 may have the negative polarity. As a result, a structure that insulates the positive electrode terminal 140 from the can housing 120 may be required, and this structure may be the insulating gasket 150. Particularly, in the example embodiment of the present invention, since the positive electrode terminal 140 is coupled to the through-hole 124 of the sidewall, the insulating gasket 150 may be configured to insulate the positive electrode terminal 140 from the sidewall 122.

The insulating sheet 160 may be a configuration that surrounds a circumference of the positive electrode tab 170. The positive electrode tab 170 may extend upward from the outermost positive electrode 111 of the electrode assembly and be bent laterally and then be bent downward again and be connected to an inner surface of the positive electrode terminal 140. In this case, the positive electrode terminal 140 may be in contact with the upper base plate 130. Since the base plate 130 has the negative polarity, a short-circuit accident occurs when the positive tab 170 and the base plate 130 are in contact with each other. Therefore, a component for preventing this accident from occurring may be the insulating sheet 160.

In the button-type secondary battery 100 according to Embodiment 1 of the present invention, the height of the electrode assembly 110 may correspond to that of the sidewall 122. Since the positive electrode terminal 140 is formed on the sidewall 122 different from that according to the relate art, the height of the electrode assembly 110 may increase without being limited by the positive electrode terminal 140. In the button-type secondary battery 100 according to Embodiment 1 of the present invention, since the height of the electrode assembly 110 inside the button cell increases, the battery capacity may increase.

In addition, in the button-type secondary battery 100 according to Embodiment 1 of the present invention, since the rivet-shaped positive electrode terminal 140 is formed on the sidewall 122 of the can housing 120, when an upper end of the cell is pressed by an impact bar during an impact test, the pressure may be distributed throughout the electrode assembly 110. This is because the impact bar strikes the base plate 130 formed in an even (or constant) plate shape as a whole. Therefore, it is possible to prevent explosion due to the occurrence of the positive/negative short-circuits from occurring by the damage of the specific area as according to the related art.

In the button-type secondary battery 100 according to Embodiment 1 of the present invention, the through-hole 124 may be formed at a height biased upward from a middle height of the sidewall 122. When formed in this manner, a space to which the negative electrode tab is connected may be sufficiently secured. In order to avoid a mutual interference and to provide a space, the negative electrode tab may also be connected to the height biased downward from the middle height of the sidewall 122.

With reference to FIG. 3, the positive electrode terminal 140 may include an external terminal part 141 disposed outside the can housing 120, an internal terminal part 142 disposed inside the can housing 120, and a connection terminal part 143 connecting the external terminal part 141 to the internal terminal part 142. Due to this shape, the positive electrode terminal 140 may have a shape of a letter I lying on its side. In this case, the positive electrode tab may have the other side connected to the internal terminal part 142 of the positive electrode terminal 140, and the negative electrode tab may have the other side connected to an inner surface of the sidewall 122.

### Embodiment 2

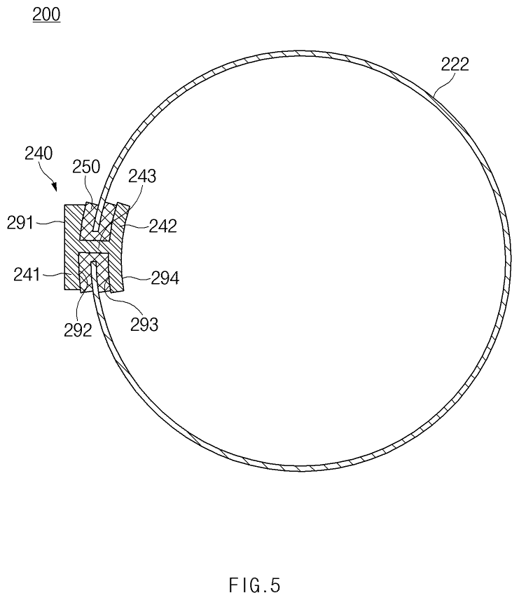

FIG. 5 is a plan view of a button-type secondary battery according to Embodiment 2 of the present invention.

Embodiment 2 of the present invention is different from Embodiment 1 in a shape of a positive electrode terminal.

The contents that are duplicated with Embodiment 1 will be omitted as much as possible, and Embodiment 2 will be described with a focus on the differences. That is, it is obvious that contents that are not described in Embodiment 2 may be regarded as the contents of Embodiment 1 if necessary.

With reference to FIG. 5, in a button-type secondary battery 200 according to Embodiment 2 of the present invention, an external terminal part 241 of a positive electrode terminal 240 may include a first surface 291 facing the outside and a second surface 292 that is a surface facing an insulating gasket 250 as a surface opposite to the first surface 291. In this case, the first surface 291 may be formed as a flat surface, and the second surface 292 may be formed as a curved surface.

The first surface 291 of the external terminal part 241 may be a portion connected to an external device. Thus, when the first surface 291 is formed in a planar shape, contact resistance may be reduced, and energy efficiency may be improved. That is, when the first surface 291, which is a portion connected to the external terminal, is formed as the curved surface, a contact area may be significantly reduced (because the external terminal is generally formed as the flat surface). However, when formed in the planar shape, since the contact area increases, more improved energy efficiency may be obtained.

In addition, since the second surface 292 of the external terminal part 241 has the curved shape, the second surface 292 of the external terminal part 241 may be coupled to be more sealed with the insulating gasket. Since the second surface 292 is a surface that is in contact with the insulating gasket 250, and the insulating gasket 250 is formed in the curved surface, when the second surface 292 and the insulating gasket 250 are formed in the same curved surface, the second surface 292 and the insulating gasket 250 may be coupled to be more sealed. That is, the second surface 292 and the insulating gasket 250 may be coupled to be in close contact with to each other without a clearance. Here, the reason in which the insulating gasket 250 is formed as the curved surface may be that, since the shape of the sidewall 222 is formed as the curved surface, the insulating gasket 250 may also be formed as the curved surface corresponding thereto.

The inner terminal part 242 of the positive electrode terminal 240 has a third surface 293, which is a surface facing the insulating gasket 250 while facing the outside, and a fourth surface 294, which is a surface facing the electrode assembly as a surface opposite to the third surface 293. In this case, each of both the third surface 293 and the fourth surface 294 may be formed as a curved surface.

The third surface 293 may be a surface facing the insulating gasket 250. Since the insulating gasket 250 is formed in the curved surface for the same reason as described above, when the third surface 293 is formed in the curved surface, the third surface 293 and the insulating gasket 250 may be coupled to be sealed to each other. That is, the close coupling may be possible without the clearance. In addition, the fourth surface 294 may be a surface facing an outer circumferential surface of the electrode assembly 110. Since the outer circumferential surface of the electrode assembly 110 is formed as the curved surface, the fourth surface 294 may be formed as a curved surface corresponding thereto. If each of both the outer circumferential surface and the fourth surface 294 of the electrode assembly are formed as the curved surface, space efficiency may be improved because an unnecessarily wasted space in the internal space is reduced.

While the example embodiments of the present invention have been described with reference to the specific example embodiments, it will be apparent to those skilled in the art that various changes and modifications may be made without departing from the spirit and scope of the invention as defined in the following claims.

### DESCRIPTION OF THE SYMBOLS

100, 200: Button-type secondary battery
110: Electrode assembly
111: Outermost positive electrode
112: Outermost negative electrode
120: Can housing
121: Bottom part
122, 222: Sidewall
123: Upper opening of sidewall
124: Through-hole
130: Base plate
140, 240: Positive electrode terminal
141, 241: External terminal part
142, 242: Internal terminal part
143, 243: Connection terminal part
150, 250: Insulating gasket
160: Insulating sheet
170: Positive electrode tab
180: Negative electrode tab
291: First surface
292: Second surface
293: Third surface
294: Fourth surface

1. A button-type secondary battery having a shape of which a diameter is greater than a height, the button-type secondary battery comprising:
an electrode assembly in which a positive electrode, a separator, and a negative electrode are alternately disposed;
a can housing comprising a bottom part and a sidewall extending upward from a circumference of the bottom part to form an internal space, the electrode assembly being disposed in the internal space formed by the bottom part and the sidewall;
a base plate configured to cover an opening at an upper end of the sidewall and coupled to the can housing;
a positive electrode terminal having a rivet shape coupled to a through-hole formed in the sidewall;
an insulating gasket configured to insulate the positive electrode terminal and the can housing from each other;
a positive electrode tab having one side connected to the positive electrode of the electrode assembly and the other side connected to the positive electrode terminal; and
a negative electrode tab having one side connected to the negative electrode of the electrode assembly and the other side connected to the sidewall.

2. The button-type secondary battery of claim 1, wherein an edge of the base plate and the upper end of the sidewall are coupled to each other by laser welding.

3. The button-type secondary battery of claim 1, wherein the electrode assembly has a height corresponding to a height of the sidewall.

4. The button-type secondary battery of claim 1, further comprising an insulating sheet configured to surround a circumference of the positive electrode tab.

5. The button-type secondary battery of claim 1, wherein:
the through-hole is formed closer to the upper end of the sidewall than to the bottom part, and
the negative electrode tab is connected to a portion of the sidewall closer to the bottom part than to the upper end.

6. The button-type secondary battery of claim 1, wherein the positive electrode terminal comprises:
an external terminal part disposed outside the can housing;
an internal terminal part disposed inside the can housing; and
a connection terminal part configured to connect the external terminal part to the internal terminal part.

7. The button-type secondary battery of claim 1, wherein:
the electrode assembly comprises a jelly-roll type electrode assembly in which the positive electrode, the separator, and the negative electrode are alternately disposed and wound, the positive electrode being an outermost positive electrode among a plurality of positive electrodes in the electrode assembly, and
the positive electrode tab has one side connected to the outermost positive electrode of the electrode assembly and the other side connected to an inner surface of the positive electrode terminal.

8. The button-type secondary battery of claim 1, wherein:
the electrode assembly comprises a jelly-roll type electrode assembly in which the positive electrode, the separator, and the negative electrode are alternately disposed and wound, the negative electrode being an outermost negative electrode among a plurality of negative electrodes in the electrode assembly, and
the negative electrode tab has one side connected to the outermost negative electrode of the electrode assembly and the other side connected to an inner surface of the sidewall.

9. The button-type secondary battery of claim 6, wherein the external terminal part comprises:
a first surface facing away from the sidewall of the can housing; and
a second surface facing the insulating gasket as a surface opposite to the first surface, and
wherein the first surface is formed as a flat surface, and the second surface is formed as a curved surface.

10. The button-type secondary battery of claim 6, wherein the internal terminal part comprises:
a third surface facing the insulating gasket; and
a fourth surface facing the electrode assembly as a surface opposite to the third surface, and
wherein each of the third surface and the fourth surface is formed as a curved surface.
